(19) United States
(12) Patent Application Publication
(10) Pub. No.: US 2009/0044319 A1
(43) Pub. Date: Feb. 19, 2009

(54) Spray Coated Foam Protective Athletic Garment

(76) Inventors: Kyle Larry Lamson, Chelmsford, MA (US); Alexander Reynolds, Wayland, MA (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 11/838,414

(22) Filed: Aug. 14, 2007

(51) Int. Cl. A41D 27/26; A41D 13/00; B05D 1/02; A41D 13/08

(52) U.S. Cl. 2/459; 2/16; 2/22; 2/455; 2/463; 2/467; 427/299

(57) ABSTRACT

A protective athletic garment for use in contact sports is formed by first forming a layer of foam. All or a portion of the foam is then compression molded to a desired shape. A layer of a durable coating is then applied to the compression foam to a desired thickness. The compression foam is then optionally coupled to a backing structure. A material overlay may then be coupled around the edges of the coated foam and optional backing structure to form a finished durable edge. Additional protective padding may then be coupled to the material overlay of the durable edge to provide additional protection.

### TECHNICAL FIELD

The present invention relates generally to sports protective garments and more particularly to a spray coated foam protective athletic garment.

### BACKGROUND OF THE INVENTION

Upper body protective garments are commonly worn by participants of contact sports for the purpose of preventing injuries to their shoulders, back, and chest. These kinds of injuries are ordinarily associated with sports such as lacrosse, hockey, and football. In these contact sports, various situations may cause upper body injuries. Examples of these situations include tackling or otherwise bumping into other players, falling to the ground, being struck by another player's equipment, or being struck by the game ball itself. Of course, upper body protective garments may reduce or prevent injuries resulting from various other circumstances, including those not associated with contact sports.

Existing upper body protective garments utilize a relatively significant amount of foam padding for absorbing the energy of blows delivered to the wearer's upper body. Moreover, a rigid cover, typically made of impact resistant plastic or another rigid material, sometimes overlays the foam padding in order to distribute the force of the blow across a larger area of the foam padding. As is known in the art, distributing the force in this manner permits the foam padding to absorb a substantial portion of the energy associated with the blow.

Protective equipment also exists to protect other parts of the body from injury during contact athletic events. Such protective equipment includes, but is not limited to, gloves, shin guards, and hip pads. This protective equipment like the upper body protective gear described above, is typically comprised of foam padding or foam padding with a plastic cover and thus suffers from the same deficiencies discussed above.

To form these garments, pre-formed foam inserts are coupled to an underlying backing structure, typically by insertion within a fabric overlay and then enclosing the fabric overlay by hand or machine stitching, a process that is both labor intensive and expensive. In addition, these foam inserts are generally bulky and not formed to conform to the underlying backing structure. As such, the foam inserts tend to restrict movement of the protective garment relative to the wearer. Further, because the foam inserts were typically die cut, the finished appearance of the resultant padding had a squared or stepped appearance where the thickness changed.

Alternatively, these protective garments may be formed wherein the foam inserts are first coupled to an underlying backing structure and the coupled structure is subsequently dipped into a bath containing a vinyl polymer material. The vinyl therein provides an outer coating for sealing the foam within the backing structure. However, similar to the method described above, the garments utilizing these foam inserts are generally bulky and not formed to conform to the underlying backing structure.

Further, in order to form pads having a desired shape and thickness, it was generally necessary to first die cut and glue together layers of foam material. This is a process that is both time consuming and labor intensive, and the resultant padding has a squared or stepped appearance where the thickness changes. Also, the vinyl coating material is not durable and has a relatively low tensile strength, and thus has a tendency to crack, rip or wear through during use. Additionally, the vinyl tends to become brittle over the course of time and may crack even without an impacting blow. Further, in order to withstand the high heat required for vinyl dip coating, the choice of foam that could be utilized is limited to heat resistant foams such as styrene-butadiene-rubber (“SBR”) foams. In addition, because the entire base structure of the pad had to be formed prior to the vinyl-dipping step, there existed very limited ways to attach straps to the vinyl-dipped pad, such as by riveting or similar attachment mechanisms.

Therefore, a need also exists for protective equipment for any part of the body that cushions against powerful blows and is relatively lightweight and long lasting. Moreover, it is highly desirable that the protective equipment is easily formed and also provides a wearer with increased range of movement.

### SUMMARY OF THE INVENTION

It is therefore an advantage of the present invention to provide protective equipment for use in contact sports that provides cushion against blows thereto.

It is another advantage of the present invention to provide protective equipment for use in contact sports that is durable and lightweight.

It is still another advantage of the present invention to provide protective equipment for use in contact sports that is easily formable and provides an increased range of movement for the wearer.

In accordance with the above and the other advantages, the present invention provides a simplified protective athletic garment, and method of manufacture, that addresses some of the deficiencies described above.

In a preferred embodiment of the present invention, the protective athletic garment is manufactured by first forming a layer of foam. All or a portion of the foam is then compression molded to a desired shape. A layer of a durable coating is then applied to the compression foam to a desired thickness. The coated foam is then optionally coupled to a material backing. A material overlay may then be coupled around the edges of the coated foam and the optional backing structure to form a finished durable edge. Additional protective padding may then be coupled to the material overlay of the durable edge to provide additional protection for a wearer.

The present invention provides a relatively simple method for forming a protective athletic garment and further provides a protective garment having adequate protection to the wearer, less bulk than conventional foam inserts, and more durability than vinyl coated protective garments. The present invention may be used to form a wide variety of protective athletic garments, including but not limited to shoulder pads, elbow pads, gloves, helmets, shin guards, and shoes for use a wide variety of sports, including contact sports such as lacrosse, hockey, boxing and soccer. The protective garments may also be utilized in other sports or activities that require some form of protective padding to protect an individual against impacts during play. For example, these protective garments may be used by individuals training in any one of the martial arts, including karate or judo. These same garments may also be utilized while competing in these activities.

Other advantages of the present invention will become apparent when viewed in light of the detailed description of the preferred embodiment when taken in conjunction with the attached drawings and appended claims.

### BRIEF DESCRIPTION OF THE DRAWINGS

For a more complete understanding of this invention, reference should now be made to the embodiments illustrated in greater detail in the accompanying drawings and described below by way of examples of the invention:

FIG. 1 is a front view of a protective athletic garment according to one embodiment of the present invention;

FIG. 2 is a rear view of the protective athletic garment of FIG. 1;

FIG. 3 is a cross-sectional view of the protective athletic garment of FIG. 1 taken along line 3-3;

FIG. 4 is logic flow diagram schematically illustrating the process for forming a protective athletic garment in accordance with the present invention; and

FIG. 5 is a front view of a protective athletic garment according to another embodiment of the present invention.

### DETAILED DESCRIPTION OF THE PREFERRED EMBODIMENT

In the following figures, the same reference numerals are used to identify the same components in the various views.

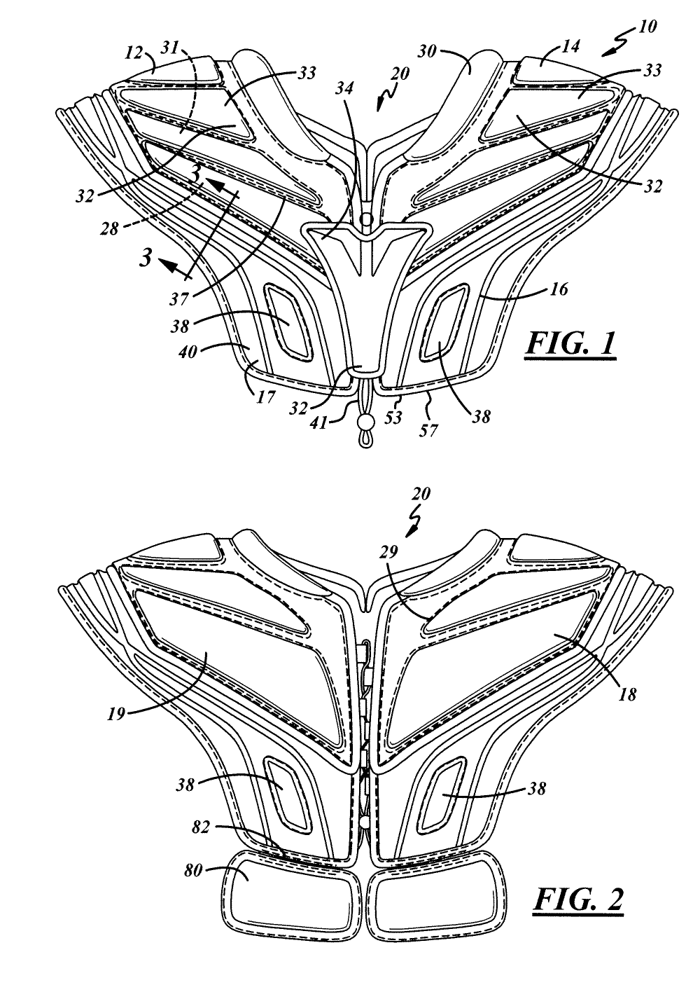

Referring to FIGS. 1-3, there is generally shown a piece of protective athletic equipment (“equipment”), otherwise known as a protective athletic garment, worn by a wearer for the purpose of cushioning against blows delivered to the wearer's body such as commonly occurs during a contact sporting event. It will be understood that the disclosed protective garment or equipment is preferably intended for use in the sport of lacrosse. However, it will be understood that the equipment may be used for a variety of other uses, including other contact sports, such as hockey, boxing, soccer, and the martial arts. Although the protective equipment preferably is for protecting the upper body of a wearer, it will be appreciated that the protective equipment formed in accordance with the present invention and tailored to the specific sport and purpose may be utilized to protect a variety of different body parts. The protective equipment may, for example, be formed in accordance with the teachings of the present invention and used to protect a wearer's elbow, shin, hand, wrist, forearm, head and hip as well as other parts of the body. For representative purposes, the protective equipment described herein in FIGS. 1-3 is a protective shoulder pad 10 that is preferably used in the game of lacrosse.

Referring now to FIGS. 1-3, the shoulder pad 10 includes a pair of shoulder protector portions 12, 14 a pair of chest protector portions 16, 17, and a pair of back protector portions 18, 19 extending therefrom. Preferably, the pair of shoulder protector portions 12, 14, the chest protector portions 16, 17 and the back protector portion 18, 19 are configured or assembled as a single unit such that the wearer can put on the shoulder pad 10 as a single unit. It will be understood that the shoulder pad 10 may take on a variety of different configurations with differently configured or oriented protector portions. Moreover, the protector portions can be secured or otherwise attached to one another in a variety of different ways and at a variety of different points as will be understood by one ordinary skill in the art.

The shoulder pad 10 includes an opening 20 generally bounded by the pair of shoulder protector portions 12,14, the chest protector portions 16,17 and the back protector portions 18, 19. The opening 20 is intended to receive a wearer's head and neck therethrough.

Each of the shoulder protector portions 12, 14, the chest protector portions 16, 17 and the back protector portions 18, 19 includes a backing structure 22 preferably having an inner material layer 24 and an outer material layer 26. The backing structure 22, however, may take on other forms well known by those in the sports equipment industry and still fall within the spirit and scope of the present invention. For example, the backing structure 22 may be a single material layer formed of a durable polymeric layer that would otherwise not be considered a material. The inner and outer material layers 24, 26 may be sewn together at various locations, preferably using thread 29, or otherwise be coupled together at various locations in other ways well known in the art.

One or more pads 28 may be sewn in between or onto the inner material layer 24 and outer material layer 26. This includes, for example, a neck roll 30 and an internal chest pad 31. The pads 28 may be formed from any number of materials, including polymeric foams, plastics, composites, rubber, and combinations thereof.

The inner material layer 24 and the outer material layer 26 may take on many forms, but preferably comprises a thin, light, durable and moisture-resistant material that conforms on an inner portion to a wearer.

In addition, one or more impact shields 32 may be sewn into or otherwise coupled onto the backing structure 22 at strategic locations to provide impact protection to a desired area. Examples of the impact shields 32 in FIG. 1 include a pair of clavicle impact shields 33 and a sternum shield 34. The impact shields 32 are preferably formed of an impact resistant plastic, metal or composite material and in one embodiment are sewn onto the outer material layer 26. One or more vent openings 38 that extend through the inner material layer 24 and outer material layer 26 may also be included in any portion of the shoulder pad 10 to provide cooling airflow to the wearer. In one embodiment, these vent openings 38 are sized to allow maximum airflow without adversely affecting the protection of the wearer from impact from a ball, stick or another player.

A drawstring 41 that is accessible below the sternum shield 34 and extends between the pair of chest protector portions 16, 17 allows the chest protector portions 16, 17 to be loosened or tightened to fit snugly against the wearer's chest. A rear string 43 also couples together the back protector portions 18, 19.

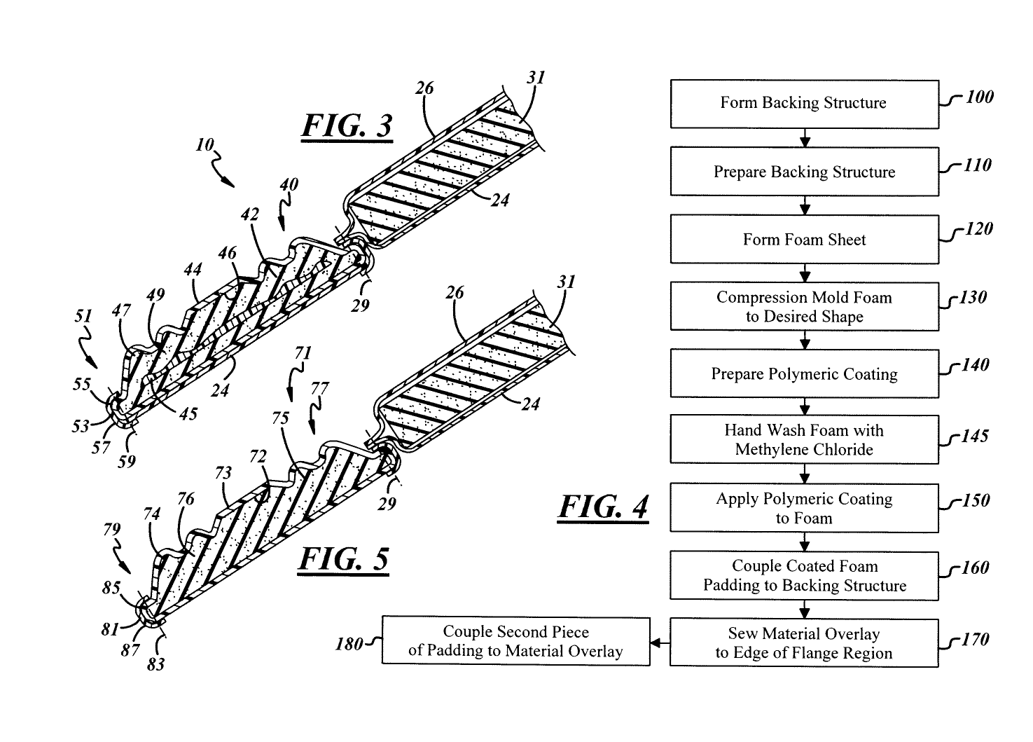

The shoulder pad 10 also includes a coated padded region 40 that is coupled to a portion, or all, or none of the backing structure 22. As best shown in FIG. 3, the coated padded region 40 consists of an inner foam material 42 having a polymeric surface coating 44 that is applied onto the outer surface 46 of the inner foam material 42.

The coated padded region 40 preferably is a single integral foam unit having areas 47, 49 of varying thickness and may include a flange region 51. Alternatively, the coated padded region 40 may be formed of multiple foam units (not shown) coupled together to a desired shape and thickness. These foam units may be formed of foam materials having similar chemical compositions and densities, or may be formed from foam materials having different chemical compositions or densities, thus allowing the shoulder pad to have different mechanical characteristics such as impact resistance. In addition, an impact resistant material such as a hard plastic shield 45 may be introduced between any two of the foam units to provide increased impact resistance at a particular desired location. Further, a layer of fabric (not shown) may be introduced between any pair of foam units that aids in maintaining alignment and further prevents the foam units from shifting relative to one another during play, which may cause wear and tear along the adjacent foam unit surfaces.

The flange region 51 may then be bound with a material overlay, or binding 53, that is preferably stitched-in with thread 59 or otherwise secured to the flange region 51 and backing structure 22 that protects the edges 55 of the coated padded region 40 and provides the shoulder pad 10 with a finished, more durable edge 57. The overlay 53 may extend and enclose a portion or the entire portion of the coated padded region 40.

Moreover, in another alternative arrangement, the addition of the material overlay 53 allows the equipment 10 to be subsequently expanded through the introduction of additional protective structures. For example, as shown in FIG. 2, an additional kidney pad 80 could be sewn onto or otherwise be attached to the material overlay 53 along a bottom portion 82 of the back protector portion 18.

While the coated padded region is preferably coupled to the outer material layer 26 and bound with the material overlay 53, alternative arrangement are contemplated in which the coated padded region 40 could be coupled to the inner material layer 24 and still fall within the spirit of the present invention.

The inner foam material 42 is preferably a foam material for absorbing the energy of blows delivered to the wearer from a ball, stick or another player during usage. The foam material 42 is preferably formed initially as a single sheet and die cut to a specific size by conventional methods well known to those of ordinary skill in the foam industry and is subsequently compression molded to a desired shape, thus allowing the foam unit to be formed having varying thickness in different areas yet still having clean edges. The foam material 42 may be formed from many different starting materials, and at different thicknesses or densities, depending upon the application, to provide sufficient protection to the wearer while providing infinite design choices for the manufacturer in terms of weight, bulk and appearance.

One preferred foam material 42 is ethyl vinyl acetate (“EVA”), while another preferred foam is polyethylene (“PE”), however other foam materials that can absorb the energy of blows in a relatively thin configuration may also be utilized. The preferred method for delivering the inner foam material 42 is to provide a preformed sheet having a particular size and shape that is compression-molded and die cut to a particular finished shape. The method for accomplishing this will be described further below.

The polymeric surface coating material 44 is preferably comprised of a durable polymeric material that adheres to the underlying foam material 44 and provides a durable, soft, highly flexible and relatively smooth finish that resists water and sweat. The preferred method for applying the coating material 44 is via a spray application, and will be described in further detail below.

The two-component polyurethane consists of a first package including a polyhydroxyl-functional polymer, solvents, catalysts, optional pigments and other additives and a second package including an unblocked polyisocyanate and any moisture-free solvents. In one embodiment, the catalyst is in a separate third package such that the cure rate can be adjusted for variations in ambient conditions. As one of ordinary skill recognizes, the polyisocyanate/polyol ratio (“NCO/OH ratio”) is controlled to allow sufficient pot life governed by chemical kinetics prior to application and to ensure complete crosslinking. Preferably, the NCO/OH ratio is slightly greater than 1/1 to ensure complete curing.

Virtually any class of polyhydroxyl-functional resin can be used. Hydroxy-terminated polyesters and hydroxy-substituted acrylic resins are the most common and most preferred, but virtually any other hydroxy-containing entity, including many alkyds, may also be utilized.

A wide variety of unblocked polyisocyanate components may be used to react with the polyhydroxy-functional resins to form the polyurethane coatings. This includes aromatic isocyanates such as toluene diisocyanate (“TDI”) and bis(4-isocyanatophenyl)methane (“MDI) and aliphatic isocyanates such as 1,6 hexamethylene diisocyanate (“HDI”), isophorone diisocyanate (“IPDI”), bis(4-isocyanatocyclohexyl)methane (“H₁₂MDI”) tetramethyl-m-xylidene diisocyanate (“TMXDI”), and isopropenyldimethylbenzylisocyanate (“TMI”). In addition, a wide variety of other coreactants may be cross-linked to the polyisocyanate prior to introduction with the first package, including some hydroxy-containing alkyds, epoxy resins such as bisphenol A, or some ketimine derivates of polyamines.

One preferred polymeric material 44 is HABBRez XPD-1063/HABBCure XPD-1062 Fast Cure High Solids Black 2 Component Polyurethane Top Coat, available from HABBCO Industries, LLC of Seekonk, Mass.

Referring now to FIG. 4, one preferred method for forming the shoulder pad 10 of FIGS. 1-3 is illustrated.

First, in Step 100, the backing structure 22 of the shoulder pad 10 is formed in its desired configuration, including containing any vent openings 38, padding 31, and impact shields 32. To accomplish this, the inner material layer 24 and the outer material layer 26 are cut or formed in their desired shapes. Next, pads 28 such as the neck roll 30 and/or the chest protector pads 31 are placed between the inner material layer 24 and the outer material layer 26. The outer material layer 24 and the inner material layer 26 are sewn together with thread 29 on their respective edges, and around any pads, to contain or maintain the pads 28 in their desired locations. Next, the impact shields 32 are coupled to the outer material layer 26 and sewn to the outer material layer 26 along its edges using thread 29.

In Step 110, the provided backing portion 22 is prepared for subsequent combination with the foam material 42. This includes cleaning the inner 24 or the outer surface materials 26 of the backing portion 22 with water or an appropriate solvent.

Next, in Step 120, the foam material 42 is formed as a sheet to a desired thickness and die cut to a specific size using cutting dies or other suitable processes.

In Step 130, the foam material 42 is placed into a hot compression mold and compressed in areas where detail is desired, including for example to form the flange regions 51. The foam material 42 having the desired shape and thickness is removed from the hot compression mold and cooled.

Next, in Step 140, the polymeric coating 44 is prepared for application. To accomplish this, the first package, the second package, and the third package (if used) are premixed into an appropriate container and adjusted to a desired application viscosity.

At the same time, in Step 145, the foam material 42 is optionally and preferably hand-washed with a desired solvent such as methylene chloride to make the outer surface of the foam material tacky and more receptive to the polymeric coating material 44. However, depending upon the tackiness or receptiveness of the foam material 42 as determined by its chemical structure and manufacturing method, this step may be unnecessary.

In Step 150, the polymeric coating 44 is applied to the surface of the foam material 42 using a spray gun or similar application device. Preferably, for the preferred two-component polyurethane, the coating 44 is applied in one or more passes to a uniform thickness of between about 2 and 10 mils. As one of ordinary skill in the art recognizes, the hydroxyl functional groups of the first package react with the isocyanate component of the second package at ambient conditions to form urethane linkages and “cure” the coating 44 to the desired thickness.

Next in Step 160, the coated foam padding 40 is coupled to the backing structure 22.

Next, in Step 170, a material overlay 53 is coupled over the edges 55 of the flange region 51 and to the underlying backing structure 22 (preferably to both the inner material structure 24 and the outer material structure 26), therein forming a finished, durable edge 57. Preferably, the material overlay 53, the flange region 51, and the backing structure 22 are coupled together with thread 59.

Further, in Step 180, a second piece of protective equipment may optionally be attached or otherwise coupled to the material overlay 53 by sewing or otherwise attaching the second piece to the material overlay. This step may be repeated to couple additional piece or pieces as desired.

In another alternative embodiment, as shown in FIG. 5, a piece of protective equipment formed entirely of the coated padded region (i.e. without the use of a backing structure).

Referring now to FIG. 5, the piece of protective equipment 71 is formed simply by spray applying a polymeric surface coating 73 to an outer surface 72 of inner foam material 75 to form a coated padded region 77. The coated padded region 77 has areas 74, 76 of varying thickness. The inner foam material 75 may include a flange region 79 that is bound with a material overlay, or binding 81, that is preferably stitched-in with thread 83 through the flange region 79 that protects the edges 85 of the coated padded region 79 and provides the coated padded region 77 with a finished, more durable edge 87. The overlay 81 may extend and enclose a portion or the entire portion of the coated padded region 77.

The inner foam material 75 is similar or the same as the inner foam material 42 of FIGS. 1-3 and formed in accordance with the methods described in Steps 120 and 130 of FIG. 4 above. As above, the inner foam material 75 may consist of one or more foam units each compression molded to a particular size and shape and then coupled together in a desired configuration. These foam units may be formed of foam materials having similar chemical compositions and densities, or may be formed from foam materials having different chemical compositions or densities, thus allowing the coated padded region 77 to have different mechanical characteristics such as impact resistance. In addition, an impact resistant material such as a hard plastic shield (not shown) may be introduced between any two of the foam units to provide increased impact resistance at a particular desired location. Further, a layer of fabric (not shown) may be introduced between any pair of foam units that aids in maintaining alignment and further prevents the foam units from shifting relative to one another during play, which may cause wear and tear along the adjacent foam unit surfaces.

The polymeric surface coating 73 is similar or the same as the polymeric surface coating 44 described above in FIGS. 1-3 and is prepared for application to the foam material 75 in the manner described in Step 140 of FIG. 4. The coated padded region 77 is therefore formed in the manner described in Steps 120, 130, 140, 145, and 150 of FIG. 4 above.

The coated padded region 77 formed as described above can find many applicable uses in its pristine form or it can be combined with other materials to form a finished piece of equipment. For example, the coated padded region 77, in its pristine form, could represent the inner shell of helmet or shin pad, wherein the coated padded region 77 is coupled to or otherwise attached to a hard plastic shell. Also, the coated padded region 77 could be introduced within a pocket of an elastic sleeve and used as an elbow pad or a kneepad. Further, the material overlay 81 could be sewn onto other otherwise attached to a separate protective garment to form an extension of that garment. For example, the protective equipment 71 could function as a kidney pad as described above as reference 80 in FIGS. 1-3.

The present invention provides a relatively simple method for forming a protective athletic garment or equipment and further provides a protective garment having adequate protection to the wearer, less bulk than conventional foam inserts, and more durability than vinyl coated protective garments. The present invention may be used to form a wide variety of protective athletic garments, including but not limited to shoulder pads, elbow pads, gloves, shin guards, helmets, hip pads, a rib pads, kidney pads, chest pads, knee pads, shin pads, and shoes, for use a wide variety of sports, including but not limited to lacrosse, hockey, and soccer.

While particular embodiments of the invention have been shown and described, numerous variations and alternate embodiments will occur to those skilled in the art. For example, other molding techniques such as pour molding or injection molding are specifically contemplated herein. Accordingly, it is intended that the invention be limited only in terms of the appended claims.

What is claimed is:

1. A method for forming a protective athletic garment comprising:
forming a foam material to a desired shape; and
spray applying a polymeric coating material to a desired thickness onto an outer surface of said foam material to form a coated padded structure.

2. A protective garment formed in accordance with the method of claim 1.

3. The method of claim 1 further comprising:
providing a backing structure; and
coupling said coated padded structure to said backing structure.

4. A protective garment formed in accordance with the method of claim 3.

5. The method of claim 1 further comprising:
compression molding at least a portion of said foam material prior to spray applying said polymeric coating.

6. The method of claim 1 further comprising:
compression molding at least a portion of said foam material to form a flange region prior to spray applying said polymeric coating.

7. The method of claim 6 further comprising:
forming a finished durable edge by coupling a material overlay over said flange region.

8. The method of claim 1, wherein said foam material is selected from the group consisting of an ethyl vinyl acetate foam material and a polyethylene foam material.

9. The method of claim 1, wherein said polymeric coating material comprises a two-component, polyurethane material.

10. The method of claim 9, wherein said two-component polyurethane material is applied to a uniform thickness of between about 2 and 10 mils.

11. The method of claim 1 further comprising:
hand washing said foam material with a suitable solvent prior to spray applying said polymeric coating material.

12. The method of claim 3 further comprising:
introducing at least one pad between an inner material portion and an outer material portion of said backing structure prior to the step of applying said foam material to said backing structure, said at least one pad located in an area of said backing structure not covered by said foam material.

13. The method of claim 3 further comprising:
introducing at least one impact shield to said backing structure prior to the step of applying said foam material to said backing structure, said at least one impact shield located in an area of said backing structure not covered by said foam material.

14. The method of claim 3, wherein said backing structure includes at least one vent hole formed therethrough.

15. The method of claim 14, wherein said at least one vent hole extends through a portion of said backing structure covered by said foam material, said at least one vent hole extending through said foam material.

16. The method of claim 7 further comprising:
coupling an additional protective structure to said material overlay.

17. A protective garment formed in accordance with the method of claim 1, said protective garment selected from the group consisting of a shoulder pad, an elbow pad, a glove, a helmet, a hip pad, a rib pad, a kidney pad, a chest pad, a knee pad and a shin pad.

18. The method of claim 1, wherein forming a foam material to a desired shape comprises:
providing at least two units of a foam material;
coupling said at least two units of said foam material to form a stacked unit; and
forming said stacked unit to a desired shape having an outer surface.

19. The method of claim 18, further comprising coupling at least one hard plastic shield between a respective pair of said at least two units of said foam material.

20. The method of claim 18, further comprising coupling at least one layer of fabric between a respective pair of said at least two units of said foam material.

21. A method for forming a protective athletic garment comprising:
providing a backing structure having an outer edge;
forming a layer of a foam material;
compression molding said layer of said foam material to a desired shape and having an outer end; and
spray applying a polymeric coating material to a desired thickness onto said foam material to form a coated padded structure;
coupling said coated padded structure to said backing structure such that said outer end is adjacent to a portion of said outer edge; and
forming a finished durable edge on said coated padded structure by attaching a material overlay over said outer edge and said portion of said backing structure.

22. The method of claim 21, wherein said desired shape includes a flange region having said outer end.

23. The method of claim 21 further comprising:
forming a finished durable edge by coupling a material overlay to said flange region and said backing structure such that said outer end of said flange region is contained between said material overlay and said backing structure.

24. The method of claim 23 further comprising:
coupling an additional protective structure to said material overlay.

25. A protective garment formed in accordance with the method of claim 21.
